(19) United States
(12) Patent Application Publication
(10) Pub. No.: US 2017/0169289 A1
(43) Pub. Date: Jun. 15, 2017

(54) HAND RECOGNIZING METHOD, SYSTEM, AND STORAGE MEDIUM

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Yanjie LI, Tianjin (CN)

(21) Appl. No.: 15/247,852

(22) Filed: Aug. 25, 2016

Related U.S. Application Data
(63) Continuation of application No. PCT/CN2016/088960, filed on Jul. 6, 2016.

(30) Foreign Application Priority Data
Dec. 15, 2015 (CN) 201510938839.4

(51) Int. Cl. G06K 9/00; G06K 9/62; G06K 9/46; G06T 7/00

(52) U.S. Cl. CPC G06K 9/00389; G06T 7/0081; G06K 9/6215; G06T 7/0093; G06K 9/6212; G06K 9/4638; G06T 2207/10024; G06T 2207/20076; G06T 2207/20072; G06T 2207/20112; G06T 2207/30196

(57) ABSTRACT

Disclosure is a hand recognizing method including: acquiring a binary image into which an image is segmented based upon the skin color of a human body; extracting a connectivity domain in the binary image as a connectivity domain to be recognized; calculating a feature vector of a corresponding sample of the connectivity domain to be recognized; calculating the distances between the feature vector of the connectivity domain to be recognized, and feature vectors of hand sample connectivity domain, and the distances between the feature vector of the connectivity domain to be recognized, and feature vectors of non-hand sample connectivity domains; obtaining K samples with the shortest distances, determining whether the number of hand samples among the K samples is more than the number of non-hand samples, and if so, then determining that the connectivity domain to be recognized is a hand feature, wherein K represents a positive odd number.

### CROSS REFERENCE TO RELATED APPLICATIONS

This application is a continuation of International Application No. PCT/CN2016/088960, filed on Jul. 6, 2016, which is based upon and claims priority to Chinese Patent Application No. 201510938839.4, filed with the Chinese Patent Office on Dec. 15, 2015 and entitled “Hand recognizing method, system, and device”, which is hereby incorporated by reference in its entirety.

### TECHNICAL FIELD

The present disclosure relates to the field of image recognition, and particularly to a hand recognizing method for detecting a hand in an image, a hand recognizing system capable of performing the hand recognizing method, and a storage medium.

### BACKGROUND

The area of a hand in an image is firstly extracted for hand gesture based human-machine interaction, where the area of a hand in an image is generally extracted at present by segmenting the image based upon the skin color of a human body, but the inventors have identified during making of the disclosure such a drawback thereof that if there is another object similar in color to the skin color, then the other object may be mistaken for a hand, thus resulting in a high error ratio.

### SUMMARY

An object of embodiments of the disclosure is to provide a hand recognizing method.

In a first aspect, an embodiment of the disclosure provides a hand recognizing method including:

acquiring a binary image into which an image is segmented based upon the skin color of a human body;

extracting a connectivity domain in the binary image as a connectivity domain to be recognized;

calculating a feature vector of a corresponding sample of the connectivity domain to be recognized;

calculating the distances between the feature vector of the connectivity domain to be recognized, and feature vectors of hand sample connectivity domain, and the distances between the feature vector of the connectivity domain to be recognized, and feature vectors of non-hand sample connectivity domains; and

obtaining K samples with the shortest distances, determining whether the number of hand samples among the K samples is more than the number of non-hand samples, and if so, then determining that the connectivity domain to be recognized is a hand feature, wherein K represents a positive odd number.

Another object of embodiments of the disclosure is to provide a hand recognizing system capable of the hand recognizing method according to the embodiments of the disclosure.

In a second aspect, an embodiment of the disclosure provides a hand recognizing system including:

an image acquiring module configured to acquire a binary image into which an image is segmented based upon the skin color of a human body;

a connectivity domain extracting module configured to extract a connectivity domain in the binary image as a connectivity domain to be recognized;

a feature vector calculating module configured to calculate a feature vector of a corresponding sample of the connectivity domain to be recognized;

a distance calculating module configured to calculate the distances between the feature vector of the connectivity domain to be recognized, and feature vectors of hand sample connectivity domain, and the distances between the feature vector of the connectivity domain to be recognized, and feature vectors of non-hand sample connectivity domains; and

a determining module configured to obtain K samples with the shortest distances, to determine whether the number of hand samples among the K samples is more than the number of non-hand samples, and if so, to determine that the connectivity domain to be recognized is a hand feature, wherein K is a positive odd number.

Still another object of embodiments of the disclosure is to provide a storage medium capable of recognizing a hand.

In a third aspect, an embodiment of the disclosure provides a hand recognizing device including an image acquiring system configured to acquire an image at a preset frequency, and an image processing system configured to segment the image into a binary image based the skin color of a human body, wherein the hand recognizing device further includes the hand recognizing system including:

at least one processor; and

a memory communicably connected with the at least one processor for storing instructions executable by the at least one processor, wherein execution of the instructions by the at least one processor causes the at least one processor:

to acquire the binary image into which an image is segmented based upon the skin color of a human body;

to extract a connectivity domain in the binary image as a connectivity domain to be recognized;

to calculate a feature vector of a corresponding sample of the connectivity domain to be recognized;

to calculate the distances between the feature vector of the connectivity domain to be recognized, and feature vectors of hand sample connectivity domain, and the distances between the feature vector of the connectivity domain to be recognized, and feature vectors of non-hand sample connectivity domains; and

to obtain K samples with the shortest distances, to determine whether the number of hand samples among the K samples is more than the number of non-hand samples, and if so, to determine that the connectivity domain to be recognized is a hand feature, wherein K is a positive odd number.

In a fourth aspect, an embodiment of the disclosure provides a hand recognizing system including a memory, one or more processors, and one or more programs, wherein the one or more programs are configured, upon being executed by the one or more processors, to perform the operations of: acquiring a binary image into which an image is segmented based upon the skin color of a human body; extracting a connectivity domain in the binary image as a connectivity domain to be recognized; calculating a feature vector of a corresponding sample of the connectivity domain to be recognized; calculating the distances between the feature vector of the connectivity domain to be recognized, and feature vectors of hand sample connectivity domain, and the distances between the feature vector of the connectivity domain to be recognized, and feature vectors of non-hand sample connectivity domains; and obtaining K samples with the shortest distances, determining whether the number of hand samples among the K samples is more than the number of non-hand samples, and if so, then determining that the connectivity domain to be recognized is a hand feature, where K represents a positive odd number.

In a fifth aspect, an embodiment of the disclosure provides a computer readable storage medium on which computer executable instructions are stored, wherein the computer executable instructions are configured to be executed by a hand recognizing system or device to perform the operations of: acquiring a binary image into which an image is segmented based upon the skin color of a human body; extracting a connectivity domain in the binary image as a connectivity domain to be recognized; calculating a feature vector of a corresponding sample of the connectivity domain to be recognized; calculating the distances between the feature vector of the connectivity domain to be recognized, and feature vectors of hand sample connectivity domain, and the distances between the feature vector of the connectivity domain to be recognized, and feature vectors of non-hand sample connectivity domains; and obtaining K samples with the shortest distances, determining whether the number of hand samples among the K samples is more than the number of non-hand samples, and if so, then determining that the connectivity domain to be recognized is a hand feature, where K represents a positive odd number.

The inventors of the disclosure have identified the problem in the prior art of a high error ratio of detecting a hand feature in an image in a hand gesture based human-machine interaction application. In view of this, a technical task to be achieved, or a technical problem to be addressed, by the disclosure has not been conceived or anticipated by those skilled in the art, so the disclosure proposes an innovative technical solution.

An advantageous effect of the embodiments of the disclosure lies in that further to the binary image into which the image is segmented based upon the skin color of a human body as in the prior art, the hand recognizing method, system, and storage medium according to the embodiments of the disclosure further obtain the K samples of the connectivity domain to be recognized in the feature-adjacent binary image, and determine whether the connectivity domain to be recognized is a hand feature, by determining whether the number of hand samples among the K samples is more than the number of non-hand samples, so that an error ratio of recognizing a hand feature can be lowered, and the accuracy of hand gesture based human-machine interaction can be improved, as compared with the prior art.

Exemplary embodiments of the disclosure will be described below in details with reference to the drawings so as to make other features of the disclosure, and their advantages become more apparent.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flow chart of a hand recognizing method according to an embodiment of the disclosure;

FIG. 2 is a schematic structural diagram of a hand recognizing system according to an embodiment of the disclosure;

FIG. 3 is a schematic structural diagram of a hand recognizing system according to an embodiment of the disclosure; and

FIG. 4 is a schematic structural diagram of a computer readable storage medium according to an embodiment of the disclosure;

FIG. 5 is a schematic structural diagram of a hand recognizing device according to an embodiment of the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

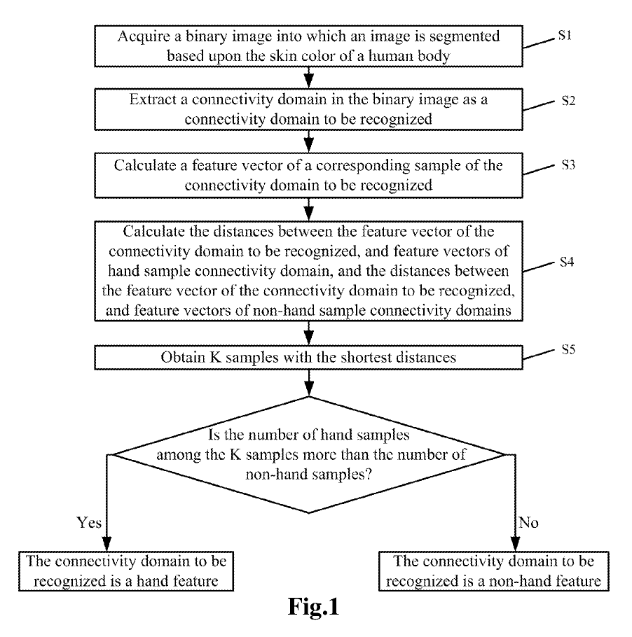

In order to address the problem in the prior art of a high error ratio of detecting a hand feature in an image in a hand gesture based human-machine interaction application, an embodiment of the disclosure provides an innovative hand recognizing method, and as illustrated in FIG. 1, a hand recognizing method according to an embodiment of the disclosure includes the following steps:

The step S1 is to acquire a binary image into which an image is segmented based upon the skin color of a human body.

Here the image is binary into the binary image based upon the skin color of a human body, typically by firstly segmenting the image into skin color and non-skin color areas using a human body skin color model, and converting the image into the binary image based upon the skin color and non-skin color areas. In this process, in order to enable the human body skin color model to better adapt to different environments and illumination conditions, the image can be further segmented by processing the image in the adaptive Gamma correction algorithm.

The step S2 is to extract a connectivity domain in the binary image as a connectivity domain to be recognized, where there may be one or more connectivity domains in the binary image, and if there are a number of connectivity domains in the binary image, then each connectivity domain will become a connectivity domain to be recognized, to thereby determine whether there is a connectivity domain of a hand feature in the binary image, and the position of the connectivity domain of the hand feature. Here only a solid area with a continuous edge in the binary image may be defined as a connectivity domain; or a hollow area with more than two (including two) continuous edges in the binary image can be defined as a connectivity domain, e.g., an annular connectivity domain.

The step S3 is to calculate a feature vector of a corresponding sample of the connectivity domain to be recognized.

Here the connectivity domain of each sample is also represented as a feature vector including at least one features, so the feature vector of the corresponding sample of the connectivity domain to be recognized is calculated in this step by calculating respective feature values of the feature vector of the corresponding sample of the connectivity domain to be recognized, so that the distances between the connectivity domain to be recognized, and the connectivity domains of the respective samples can be calculated, where the distance reflects the difference between the connectivity domain to be recognized, and the sample, so that the shorter the distance is, the smaller the difference will be; and the longer the distance is, the larger the difference will be.

The feature vector can include at least one of features including the ratio of the square of the perimeter of the corresponding connectivity domain to the area of the corresponding connectivity domain, the area of the corresponding connectivity domain, the average of probabilities, derived using a Gaussian hybrid model, that pixies of the corresponding connectivity domain belong to the skin of a human body, and the average of probabilities, derived using a color histogram, that pixies of the corresponding connectivity domain belong to the skin of a human body. In a particular embodiment of the disclosure, the feature vector includes all the features above. The color histogram can include at least one of a histogram based upon a Hue, Saturation, and Value (HSV) space, a histogram based upon a Luv (L represents the luminance of an object, and u and v represent the chrome thereof) space, and a histogram based upon an Lab (L: represents the luminance of an object, and a and b represents opposite dimensions of a color thereof) space, and in a particular embodiment of the disclosure, only a histogram based upon an HSV space is applied.

The step S4 is to calculate the distances between the feature vector of the connectivity domain to be recognized, and feature vectors of hand sample connectivity domain, and the distances between the feature vector of the connectivity domain to be recognized, and feature vectors of non-hand sample connectivity domains.

If hand samples and non-hand samples are acquired, then feature vectors of hand sample connectivity domains, and feature vectors of non-hand sample connectivity domains will be calculated directly and stored in a system capable of performing the hand recognizing method according to the embodiment of the disclosure, so that the feature vectors of the hand sample connectivity domains, and the feature vectors of the non-hand sample connectivity domains can be retrieved, and the distances can be calculated, directly in this step.

Each of the distances can be a distance corresponding to an Lp norm, where if p is equal to 1, then the distance will be a Manhattan distance; if p is equal to 2, then the distance will be a Euclid distance; and if p is infinite, then the distance will be a Chebyshev distance. In a particular embodiment of the disclosure, the distance is an Euclid distance.

The distance can alternatively be a cosine distance, a power distance, etc., where the power distance is advantageous in that different weights can be set for different features to thereby improve the accuracy of detection.

The distance can alternatively be a Markov distance, a weighted Euclid distance, or another distance capable of reflecting the similarity between two feature vectors.

Since the distances between the feature vector of the connectivity domain to be recognized, and the feature vectors of the respective sample connectivity domains need to be calculated in this step, the number of samples may be determined taking into account both the calculation workload and the accuracy; and in view of this, respective 100 to 300, e.g., 200, hand samples and non-hand samples can be acquired respectively, where preferably the number of hand samples is the same as the number of non-hand samples to thereby improve the accuracy of detection.

The step S5 is to obtain K samples with the shortest distances, to determine whether the number of hand samples among the K samples is more than the number of non-hand samples, and if so, to determine that the connectivity domain to be recognized is a hand feature, that is, if it is determined that the number of hand samples among the K samples is more than the number of non-hand samples, to determine the connectivity domain to be recognized, as a hand feature, where K represents an odd number; and of course, those skilled in the art shall appreciate that K represents the number of samples, which may not be negative, that is, K is a positive odd number.

Of course, it can be determined whether the number of hand samples among the K samples is more than the number of non-hand samples, by determining the connectivity domain to be recognized, as a non-hand feature upon determining that the number of hand samples among the K samples is less than the number of non-hand samples.

As can be apparent, in the hand recognizing method according to the embodiment of the disclosure, K samples of the connectivity domain to be recognized in the feature-adjacent binary image can be acquired, and it can be determined whether the connectivity domain to be recognized is a hand feature, by determining whether the number of hand samples among the K samples is more than the number of non-hand samples, so that an error ratio of recognizing a hand feature can be lowered, and the accuracy of hand gesture based human-machine interaction can be improved, as compared with the prior art in which a hand feature is determined directly from the binary image into which the image is segmented based upon the skin color of a human body.

In order to improve the processing speed of hand recognition, in a particular embodiment of the disclosure, the hand recognizing method further includes the following steps:

The step A is to generate a list of current results corresponding to the connectivity domain to be recognized, where if there are more than two connectivity domains to be recognized, in the binary image, then the list of current results will include results corresponding to the respective connectivity domains to be recognized.

The step B is, if the distance between the feature vector of the connectivity domain to be recognized, and a feature vector of a sample connectivity domain is calculated, to add an entry including the calculated distance and a corresponding type of sample to the list of current results in an order of ascending distances.

Hereupon the K samples with the shortest distances can be obtained particularly as follows:

After the distances between the feature vector of the connectivity domain to be recognized, and the feature vectors of the respective sample connectivity domains are calculated, the mostly highly ranked K samples are retrieved from the list of current results, that is, the samples recorded in the first K entries are retrieved from the list of current results.

In order to further improve the processing speed of hand recognition, the hand recognizing method according to the embodiment of the disclosure can further include the step of: releasing a storage space of the list of current results corresponding to the connectivity domain to be recognized, after it is determined whether the connectivity domain to be recognized is a hand feature.

In order to enable the hand recognizing method according to the embodiment of the disclosure to support an application in which a user adjusts the value of K as a function of the accuracy of recognition, in a particular embodiment of the disclosure, the hand recognizing method according to the embodiment of the disclosure can further include: updating the value of K with a preset value of K input by a user upon reception of the preset value of K input by the user.

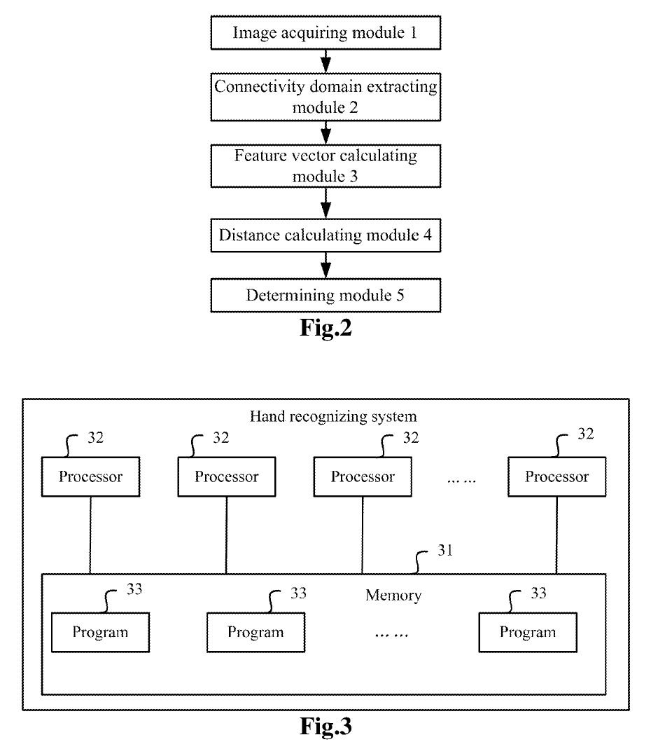

An embodiment of the disclosure further provides a hand recognizing system capable of performing the hand recognizing method according to the embodiment of the disclosure, as illustrated in FIG. 2, where the hand recognizing system includes an image acquiring module 1, a connectivity domain extracting module 2, a feature vector calculating module 3, a distance calculating module 4, and a determining module 5, where the image acquiring module 1 is configured to acquire a binary image into which an image is segmented based upon the skin color of a human body; the connectivity domain extracting module 2 is configured to extract a connectivity domain in the binary image as a connectivity domain to be recognized; the feature vector calculating module 3 is configured to calculate a feature vector of a corresponding sample of the connectivity domain to be recognized; the distance calculating module 4 is configured to calculate the distances between the feature vector of the connectivity domain to be recognized, and feature vectors of hand sample connectivity domain, and the distances between the feature vector of the connectivity domain to be recognized, and feature vectors of non-hand sample connectivity domains; and the determining module 5 is configured to obtain K samples with the shortest distances, to determine whether the number of hand samples among the K samples is more than the number of non-hand samples, and if so, to determine that the connectivity domain to be recognized is a hand feature, that is, if it is determined that the number of hand samples among the K samples is more than the number of non-hand samples, to determine the connectivity domain to be recognized, as a hand feature, where K represents an odd number; and of course, those skilled in the art shall appreciate that K represents the number of samples, which may not be negative, that is, K is a positive odd number.

In a particular embodiment of the disclosure, the hand recognizing system further includes a list generating module (not illustrated) and a result recording module (not illustrated), where the list generating module is configured to generate a list of current results corresponding to the connectivity domain to be recognized; and the result recording module is configured to, if the distance between the feature vector of the connectivity domain to be recognized, and a feature vector of a sample connectivity domain is calculated, to add an entry including the calculated distance and a corresponding type of sample to the list of current results in an order of ascending distances. Hereupon the determining module 5 is configured to retrieve the mostly highly ranked K samples from the list of current results after the distance calculating module 4 calculates the distances between the feature vector of the connectivity domain to be recognized, and the feature vectors of the respective sample connectivity domains.

In a particular embodiment of the disclosure, the hand recognizing system further includes an inputting module (not illustrated) and an updating module (not illustrated), where the inputting module is configured to receive a preset value of K input by a user; and the updating module is configured to update the value of K with the preset value of K input by the user when the inputting module receives the preset value of K.

An embodiment of the disclosure further provides a hand recognizing device capable of lowering an error ratio, as illustrated in FIG. 5, where the device includes an image acquiring system, an image processing system, and the hand recognizing system according to the embodiment of the disclosure, where the image acquiring system is configured to acquire and provide the image processing system with the image, and the image processing system is configured to segment the image into the binary image based the skin color of a human body, and to provide the hand recognizing system with the binary image.

Moreover the hand recognizing device can further include a coordinate determining system (not illustrated) configured to determine positional coordinates of the connectivity domain to be recognized of the hand feature in the image.

As illustrated in FIG. 3, there is a schematic structural diagram of a hand recognizing system according to an embodiment of the disclosure, which includes a memory 31, one or more processors 32, and one or more programs 33, each program 33 includes at least one instruction, where the one or more programs 33 are configured, upon being executed by the one or more processors 32, to perform the operations of: acquiring a binary image into which an image is segmented based upon the skin color of a human body; extracting a connectivity domain in the binary image as a connectivity domain to be recognized; calculating a feature vector of a corresponding sample of the connectivity domain to be recognized; calculating the distances between the feature vector of the connectivity domain to be recognized, and feature vectors of hand sample connectivity domain, and the distances between the feature vector of the connectivity domain to be recognized, and feature vectors of non-hand sample connectivity domains; and obtaining K samples with the shortest distances, determining whether the number of hand samples among the K samples is more than the number of non-hand samples, and if so, then determining that the connectivity domain to be recognized is a hand feature, where K represents a positive odd number.

An embodiment of the disclosure further provides a computer readable storage medium on which computer executable instructions are stored, where the computer executable instructions are configured, upon being executed by a hand recognizing system or device, to perform the operations of: acquiring a binary image into which an image is segmented based upon the skin color of a human body; extracting a connectivity domain in the binary image as a connectivity domain to be recognized; calculating a feature vector of a corresponding sample of the connectivity domain to be recognized; calculating the distances between the feature vector of the connectivity domain to be recognized, and feature vectors of hand sample connectivity domain, and the distances between the feature vector of the connectivity domain to be recognized, and feature vectors of non-hand sample connectivity domains; and obtaining K samples with the shortest distances, determining whether the number of hand samples among the K samples is more than the number of non-hand samples, and if so, then determining that the connectivity domain to be recognized is a hand feature, where K represents a positive odd number.

Where the feature vector comprises at least one of features including the ratio of the square of the perimeter of the corresponding connectivity domain to the area of the corresponding connectivity domain, the area of the corresponding connectivity domain, the average of probabilities, derived using a Gaussian hybrid model, that pixies of the corresponding connectivity domain belong to the skin of a human body, and the average of probabilities, derived using a color histogram, that pixies of the corresponding connectivity domain belong to the skin of a human body.

Where execution of the instructions by the electronic device further causes the electronic device: to generate a list of current results corresponding to the connectivity domain to be recognized; and if the distance between the feature vector of the connectivity domain to be recognized, and a feature vector of a sample connectivity domain is calculated, to add an entry comprising the calculated distance and a corresponding type of sample to the list of current results in an order of ascending distances; and to retrieve the mostly highly ranked K samples from the list of current results after the distance calculating module calculates the distances between the feature vector of the connectivity domain to be recognized, and the feature vectors of the respective sample connectivity domains.

Where execution of the instructions by the electronic device further causes the electronic device: to generate a list of current results corresponding to the connectivity domain to be recognized; and if the distance between the feature vector of the connectivity domain to be recognized, and a feature vector of a sample connectivity domain is calculated, to add an entry comprising the calculated distance and a corresponding type of sample to the list of current results in an order of ascending distances; and to retrieve the mostly highly ranked K samples from the list of current results after the distance calculating module calculates the distances between the feature vector of the connectivity domain to be recognized, and the feature vectors of the respective sample connectivity domains.

Wherein execution of the instructions by the electronic device further causes the electronic device: to receive a preset value of K input by a user; and to update the value of K with the preset value of K input by the user when the inputting module receives the preset value of K.

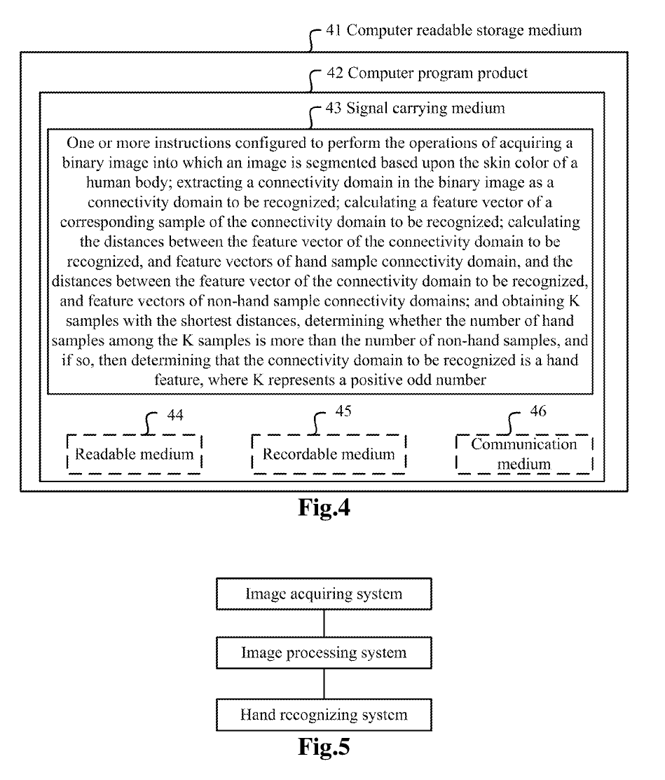

As illustrated in FIG. 4, a computer readable storage medium 41 stores thereon a computer program product 42 which can include any combination of one or more readable mediums, e.g., a signal carrying medium 43, a readable medium 44, a recordable medium 45, a communication medium 46, etc., and the signal carrying medium 43 stores therein one or more instructions configured to perform the operations of: acquiring a binary image into which an image is segmented based upon the skin color of a human body; extracting a connectivity domain in the binary image as a connectivity domain to be recognized; calculating a feature vector of a corresponding sample of the connectivity domain to be recognized; calculating the distances between the feature vector of the connectivity domain to be recognized, and feature vectors of hand sample connectivity domain, and the distances between the feature vector of the connectivity domain to be recognized, and feature vectors of non-hand sample connectivity domains; and obtaining K samples with the shortest distances, determining whether the number of hand samples among the K samples is more than the number of non-hand samples, and if so, then determining that the connectivity domain to be recognized is a hand feature, where K represents a positive odd number.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed:

1. A hand recognizing method, at a hand recognizing system, comprising:
acquiring a binary image into which an image is segmented based upon the skin color of a human body;
extracting a connectivity domain in the binary image as a connectivity domain to be recognized;
calculating a feature vector of a corresponding sample of the connectivity domain to be recognized;
calculating the distances between the feature vector of the connectivity domain to be recognized, and feature vectors of hand sample connectivity domain, and the distances between the feature vector of the connectivity domain to be recognized, and feature vectors of non-hand sample connectivity domains; and
obtaining K samples with the shortest distances, determining whether the number of hand samples among the K samples is more than the number of non-hand samples, and if so, then determining that the connectivity domain to be recognized is a hand feature, wherein K represents a positive odd number.

2. The hand recognizing method according to claim 1, wherein the feature vector comprises at least one of features including the ratio of the square of the perimeter of the corresponding connectivity domain to the area of the corresponding connectivity domain, the area of the corresponding connectivity domain, the average of probabilities, derived using a Gaussian hybrid model, that pixies of the corresponding connectivity domain belong to the skin of a human body, and the average of probabilities, derived using a color histogram, that pixies of the corresponding connectivity domain belong to the skin of a human body.

3. The hand recognizing method according to claim 1, wherein the distance is a distance corresponding to an Lp norm, a cosine distance, or a power distance.

4. The hand recognizing method according to claim 1, wherein the hand recognizing method further comprises:
generating a list of current results corresponding to the connectivity domain to be recognized; and
if the distance between the feature vector of the connectivity domain to be recognized, and a feature vector of a sample connectivity domain is calculated, then add an entry comprising the calculated distance and a corresponding type of sample to the list of current results in an order of ascending distances; and
obtaining the K samples with the shortest distances comprises:
retrieving the mostly highly ranked K samples from the list of current results after the distances between the feature vector of the connectivity domain to be recognized, and the feature vectors of the respective sample connectivity domains are calculated.

5. The hand recognizing method according to claim 1, wherein the hand recognizing method further comprises:
updating the value of K with a preset value of K input by a user upon reception of the preset value of K input by the user.

6. A hand recognizing system, comprising:
at least one processor; and
a memory communicably connected with the at least one processor for storing instructions executable by the at least one processor, wherein execution of the instructions by the at least one processor causes the at least one processor:
to acquire a binary image into which an image is segmented based upon the skin color of a human body;
to extract a connectivity domain in the binary image as a connectivity domain to be recognized;
to calculate a feature vector of a corresponding sample of the connectivity domain to be recognized;
to calculate the distances between the feature vector of the connectivity domain to be recognized, and feature vectors of hand sample connectivity domain, and the distances between the feature vector of the connectivity domain to be recognized, and feature vectors of non-hand sample connectivity domains; and
to obtain K samples with the shortest distances, to determine whether the number of hand samples among the K samples is more than the number of non-hand samples, and if so, to determine that the connectivity domain to be recognized is a hand feature, wherein K is a positive odd number.

7. The hand recognizing system according to claim 6, wherein the feature vector comprises at least one of features including the ratio of the square of the perimeter of the corresponding connectivity domain to the area of the corresponding connectivity domain, the area of the corresponding connectivity domain, the average of probabilities, derived using a Gaussian hybrid model, that pixies of the corresponding connectivity domain belong to the skin of a human body, and the average of probabilities, derived using a color histogram, that pixies of the corresponding connectivity domain belong to the skin of a human body.

8. The hand recognizing system according to claim 6, wherein execution of the instructions by the at least one processor further causes the at least one processor:
to generate a list of current results corresponding to the connectivity domain to be recognized; and
if the distance between the feature vector of the connectivity domain to be recognized, and a feature vector of a sample connectivity domain is calculated, to add an entry comprising the calculated distance and a corresponding type of sample to the list of current results in an order of ascending distances; and
to retrieve the mostly highly ranked K samples from the list of current results after the distance calculating module calculates the distances between the feature vector of the connectivity domain to be recognized, and the feature vectors of the respective sample connectivity domains.

9. The hand recognizing system according to claim 6, wherein execution of the instructions by the at least one processor further causes the at least one processor:
to receive a preset value of K input by a user; and
to update the value of K with the preset value of K input by the user when the inputting module receives the preset value of K.

10. A non-transitory computer-readable storage medium storing executable instructions that, when executed by an electronic device with a touch-sensitive display, cause the electronic device:
to acquire a binary image into which an image is segmented based upon the skin color of a human body;
to extract a connectivity domain in the binary image as a connectivity domain to be recognized;
to calculate a feature vector of a corresponding sample of the connectivity domain to be recognized;
to calculate the distances between the feature vector of the connectivity domain to be recognized, and feature vectors of hand sample connectivity domain, and the distances between the feature vector of the connectivity domain to be recognized, and feature vectors of non-hand sample connectivity domains; and
to obtain K samples with the shortest distances, to determine whether the number of hand samples among the K samples is more than the number of non-hand samples, and if so, to determine that the connectivity domain to be recognized is a hand feature, wherein K is a positive odd number.

11. The storage medium according to claim 10, wherein the feature vector comprises at least one of features including the ratio of the square of the perimeter of the corresponding connectivity domain to the area of the corresponding connectivity domain, the area of the corresponding connectivity domain, the average of probabilities, derived using a Gaussian hybrid model, that pixies of the corresponding connectivity domain belong to the skin of a human body, and the average of probabilities, derived using a color histogram, that pixies of the corresponding connectivity domain belong to the skin of a human body.

12. The storage medium according to claim 10, wherein execution of the instructions by the electronic device further causes the electronic device:
to generate a list of current results corresponding to the connectivity domain to be recognized; and
if the distance between the feature vector of the connectivity domain to be recognized, and a feature vector of a sample connectivity domain is calculated, to add an entry comprising the calculated distance and a corresponding type of sample to the list of current results in an order of ascending distances; and
to retrieve the mostly highly ranked K samples from the list of current results after the distance calculating module calculates the distances between the feature vector of the connectivity domain to be recognized, and the feature vectors of the respective sample connectivity domains.

13. The storage medium according to claim 10, wherein execution of the instructions by the electronic device further causes the electronic device:
to receive a preset value of K input by a user; and
to update the value of K with the preset value of K input by the user when the inputting module receives the preset value of K.
